(19) United States
(12) Patent Application Publication
(10) Pub. No.: US 2021/0014197 A1
(43) Pub. Date: Jan. 14, 2021

(54) DYNAMIC ENDPOINT ISOLATION IN A CRYPTOGRAPHICALLY-SEGMENTED NETWORK

(71) Applicants: Andrew F. Sanderson, Havertown, PA (US); Albert L. French, Schwenksville, PA (US); Sarah K. Inforzato, Downington, PA (US); Lemoine D. Keiper, III, Coatesville, PA (US)

(72) Inventors: Andrew F. Sanderson, Havertown, PA (US); Albert L. French, Schwenksville, PA (US); Sarah K. Inforzato, Downington, PA (US); Lemoine D. Keiper, III, Coatesville, PA (US)

(73) Assignee: Unisys Corporation, Blue Bell, PA (US)

(21) Appl. No.: 16/509,618

(22) Filed: Jul. 12, 2019

(51) Int. Cl. H04L 29/06

(52) U.S. Cl. CPC H04L 63/0218; H04L 63/1491; H04L 63/0876

(57) ABSTRACT

In a cryptographically-segmented network, a server establishes a cryptographically-segmented communication channel for use by authorized endpoints in an operationally-deployed configuration. In response to a received endpoint-isolation command to isolate a first endpoint, the server de-authorizes the first endpoint from the channel of the operationally-deployed configuration. In response to the de-authorization, the server issues a configuration instruction to the first endpoint to join a first cryptographically-segmented isolation communication channel that is communicatively coupled with at least one monitoring endpoint configured to monitor operation of the first endpoint via the first cryptographically-segmented isolation communication channel.

The instant disclosure relates to network communications. More specifically, this disclosure relates to securing network communications and managing endpoint security.

### BACKGROUND

Security is conventionally maintained in organizations by segregating physical networks used by each group of users. This acts to restrict access to data available on computers and databases used in such networks. For example, the physical segregation prevents a user in engineering from gaining access to data in the payroll department's network and vice versa. While separate local network infrastructures help to maintain security of data, superfluous equipment and maintenance is required to maintain these segregated networks. This increases expenses and complexity to the data infrastructures of organizations.

Regardless of the organizational structure of networks used in commercial, governmental, and other settings, there is an ever increasing security concern that sensitive data transmitted or stored on local networks will be accessed by an unauthorized individual or accidentally accessed or disclosed outside of a group of users, which would compromise the security of the data. Whether a security threat is intentional or unintentional, transmitting data exclusively in one security level partitioned network or another does not protect the data if it is in plaintext format. This is because even strict physical segregation of a network by security level is no guarantee that data will not be disseminated to end-users outside that security level.

### SUMMARY

Aspects of the embodiments are directed to operating a cryptographically-segmented network. According to some embodiments, a server on the network establishes at least one cryptographically-segmented communication channel for use by authorized endpoints in an operationally-deployed configuration. In response to a received endpoint-isolation command to isolate a first endpoint, the server de-authorizes the first endpoint from the at least one cryptographically-segmented communication channel in the operationally-deployed configuration. In response to the de-authorizing of the first endpoint from the at least one cryptographically-segmented communication channel in the operationally-deployed configuration, the server issues a configuration instruction to the first endpoint to join a first cryptographically-segmented isolation communication channel that is cryptographically isolated from the at least one cryptographically-segmented communication channel in the operationally-deployed configuration. The first cryptographically-segmented isolation communication channel is communicatively coupled with at least one monitoring endpoint configured to monitor operation of the first endpoint via the first cryptographically-segmented isolation communication channel.

### BRIEF DESCRIPTION OF THE DRAWINGS

For a more complete understanding of the disclosed system and methods, reference is now made to the following descriptions taken in conjunction with the accompanying drawings.

FIG. 1 illustrates a distributed system using according to one embodiment of the present disclosure.

FIG. 2 shows an organization in which separate intranets able to be formed in the distributed system of FIG. 1 are consolidated into a single interconnected infrastructure.

FIG. 3 is a chart illustrating end-users and their membership denoted by an “X” to different communities-of-interest of a small subset of an example larger organization.

FIG. 4 illustrates an example logical computing environment in which an encryption key is used to encrypt a cryptographic data set transferred from a first computing device to a second computing device.

FIG. 5 illustrates a general purpose computing system for use in implementing as one or more computing embodiments of the present disclosure.

FIG. 6 illustrates an example communications infrastructure useable within a computing environment to manage secure and clear text communications, according to various aspects of the present disclosure.

FIG. 7 illustrates an exemplary method for securely transmitting a cryptographic data set among logically partitioned data paths.

FIG. 8 illustrates an exemplary method for securely transmitting a message among logically partitioned data paths.

FIG. 9 illustrates an overall logical flow of how an original packet is containing a cryptographic data set, or message, is concatenated with preheader and then split into portions which are appended with an IP header containing a value indicating which set of data the portion belongs.

FIG. 10A is a block diagram illustrating an example architecture of a cryptographically-segmented network according to aspects of the present subject matter.

FIG. 10B is a diagram illustrating the cryptographically-segmented network of FIG. 10A with an endpoint having been isolated.

FIGS. 11A-11C are diagrams illustrating a related architecture of a cryptographically-segmented network that supports endpoint isolation, according to some embodiments.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In general, the present disclosure relates to a method, apparatus, and article of manufacture for securely isolating an endpoint in a cryptographically-segmented network, such as a network that uses micro-segmentation.

### I. GENERALIZED INFRASTRUCTURE FOR SECURE COMMUNICATION

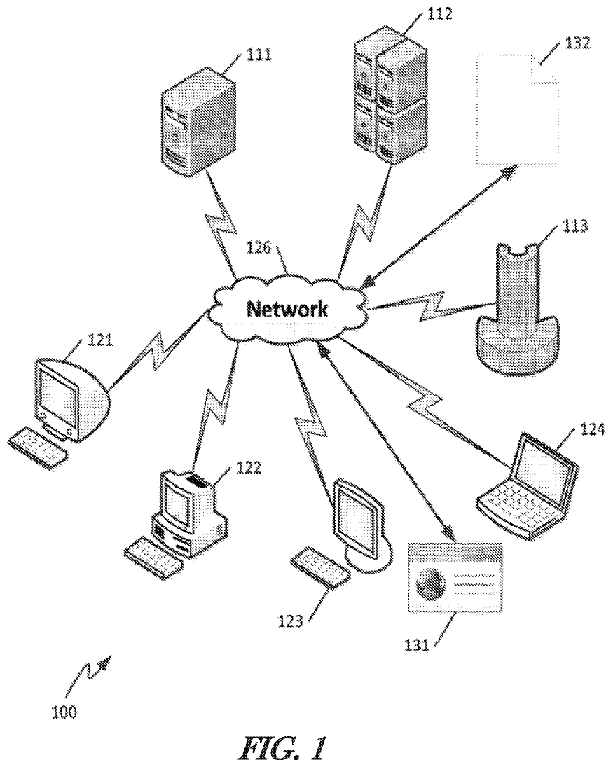

FIG. 1 illustrates a distributed system 100 in which aspects of the present disclosure can be implemented, according to one embodiment of the present disclosure. A distributed computing system 100 allows a number of users to communicate with any number of servers 111-113 using their own client computers 121-124, via a network, show as the internet 126. On a client computer 123, a web page 131 or other network-accessible resource can be displayed to a user that corresponds to a transaction 132 being performed on a particular server, e.g., server 112. The communications between the client computer 123 and server 112 occurs over a secure connection.

In various embodiments of the present disclosure, the servers 111-113 can be distributed across a plurality of discrete locations or controlled by different entities; in such embodiments, these servers 111-113 can be referred to generally as remote servers, as they represent servers accessible from a remote location and which can be accessed via an unsecured network. For example, in some embodiments of the present disclosure (discussed in greater detail below), one or more of the servers 111-113 is a banking server, configured to communicate securely with one or more client terminal devices across a secure connection, formed over a potentially unsecure network such as the Internet. In such examples, or others where a high level of security is required, one or more secure connections can be established between client devices and a server, or among servers, on such an unsecured network. Other server functionalities or arrangements are possible as well, for example including administration, provisioning, and user management/authentication systems. In such embodiments, one or more such separate functionalities can be integrated into, or can reside separate from, an entity requiring highly secure communications such as a financial institution where reliable security is needed.

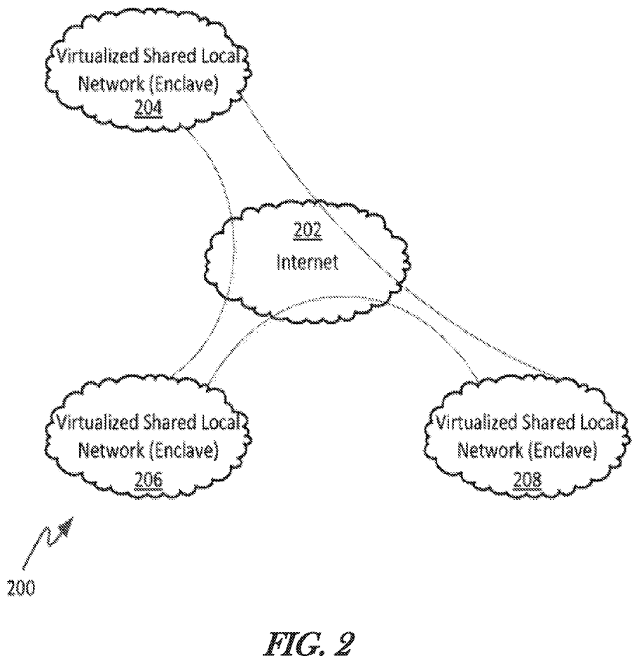

FIG. 2 shows an organization 200 in which separate intranets formed in the distributed system of FIG. 1 are consolidated into a single interconnected infrastructure. In the organization 200 as shown, a variety of physically separated resources, illustrated as residing at sites 204, 206, 208, respectively, can be communicatively interconnected, for example via the Internet 202. In accordance with the present disclosure, secure communication can be accomplished among the various sites 204-208, and from remote users to one or more sites. For example, one or more of the servers 111-113 can be physically located at a different location from other servers, and client computers 121-124 can be located at any location either within an entity's intranet or external to that intranet. Access to the resources of the organization 200 by a user is provided not based on that user's location, but his/her membership in a COI associated with that entity.

As used in the present disclosure, a community of interest (COI) refers generally to a group of two or more people, users, organizations, or entities who share a common interest and are grouped together based on their common interest. A COI may correspond to a role of an individual in an organization, a job level, security level, or may correspond to some other characteristic. A COI may also correspond to some subject defined by an organization or an individual and associated with one or more individuals (i.e., end-users of a computing device). A COI may be defined differently depending on the organizational structure of the entity.

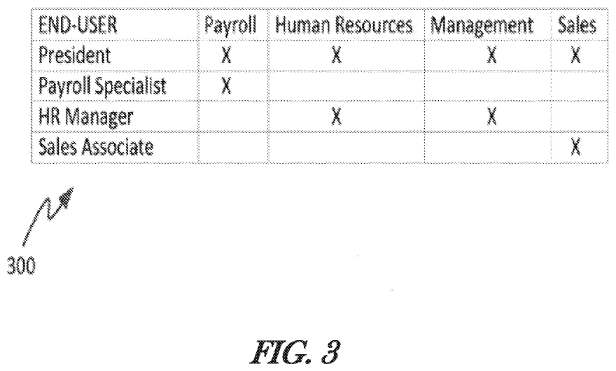

FIG. 3 is a chart 300 illustrating end-users and their membership denoted by an “X” to different communities-of-interest of a small subset of an example organization. In this condensed example, a President of an organization, given his/her position, is entitled to access data in all of the communities-of-interest. On the other hand, a Payroll Specialist whose role may be limited to only issuing paychecks can only view or share data associated with the payroll COI and no other communities-of-interest. An HR (Human Resources) Manager given his/her position in HR as well as being a manager may view or share data from both the HR and Management communities-of-interest. Finally, in this example, a Sales Associate is only able to view data from or share data with others associated with the Sales COI.

In the example shown, while the President can access data in all four communities-of-interest, the President cannot share data with the Payroll Specialist if the data the President sends to the Payroll Specialist is encrypted for use in a COI that the Payroll Specialist cannot access. That is, no communication session can be established between the President and the Payroll Specialist other than within the Payroll COI. Therefore the message with a COI key not associated with the Payroll Specialist cannot be sent to the Payroll Specialist. Even if the message is accidentally received by the Payroll Specialist, the Payroll Specialist cannot view the message, for example due to use of encryption keys specific to each community of interest, as discussed in further detail below. This safeguard prevents inadvertent or malicious/intentional dissemination of plaintext data to individuals who are not members of a particular COI, and therefore, are not authorized to receive such information.

It is possible to distribute COI-specific encryption keys (also referred to herein as “COI keys”) within departments, groups, agencies, different offices of an entity, based on ranks of individuals, security level ratings of individuals, commercial/non-commercial entities, governmental/non-governmental entities, corporations, or just about any group. It is also possible to dynamically create a COI or revoke membership in a COI by the dissemination or removal of COI keys.

Thus, in accordance with one embodiment, each individual (or end user) associated with an organization has one or more COI keys provided on their computers, which is a secret encryption and/or decryption key previously installed thereon as a set of code or logic on a computer. Only endpoint devices with matching COI keys can communicate with one another, or observe data encrypted within their COI. That is, each COI key is associated with an end-user's COI (such as a position in a company or a security level), thereby allowing only end-users within the same group and having at least the same COI key to communicate with each other, or to gain access to data associated with that COI.

Of course, multiple COI keys can be distributed to individuals based on their membership and roles. It is conceivable that select end-users in each COI, may have more access to certain data, while others may have less ability to view or share data. The use of COI keys allows for the sharing or accessing of data to end-users whose computers have been preconfigured with appropriate COI keys.

COI keys may also be installed on servers or other platforms within a network to protect sensitive data. Servers dedicated to a particular COI may only communicate with computing devices that have the same requisite COI keys installed therein. Otherwise no communication session can be established between a computing device and a server without both devices having the requisite key(s). Details regarding particular implementations in which a user device connects to server systems based on shared COI keys are described below.

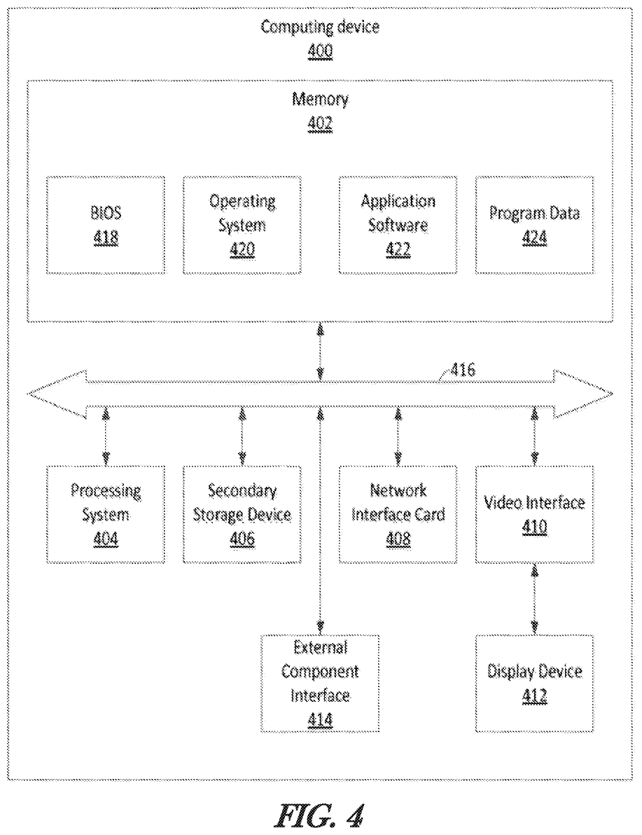

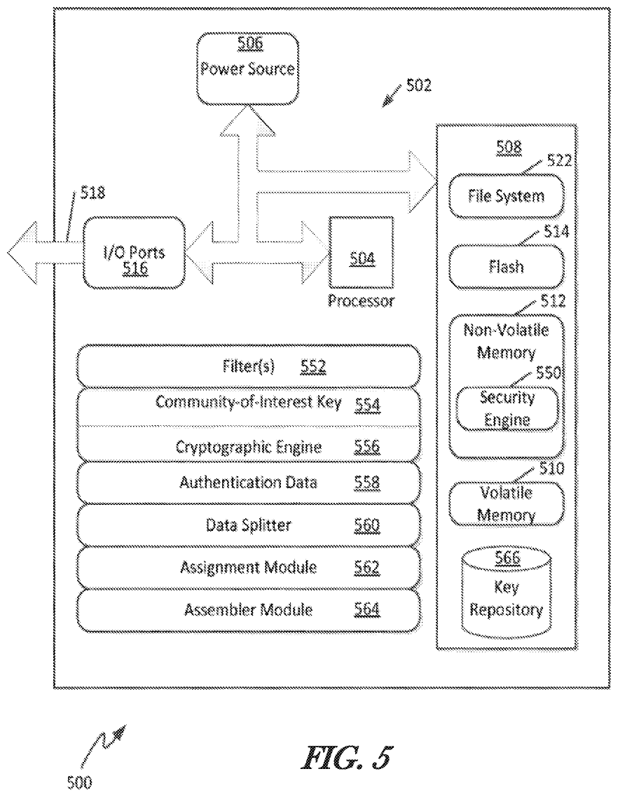

Referring now to FIGS. 4-6, various components of a computing device are disclosed, with which aspects of the present disclosure can be implemented. With reference to FIGS. 4-5, exemplary physical and logical organizations of systems are shown in which aspects of the present disclosure can be implemented. Although some of the discussion below will focus on end-user equipment such as personal computers, the applicability of the present invention is not limited to end-user equipment, and may be used with other computing devices within a network. For example, computing devices according to the present disclosure may be other general or special purpose computing devices, such as, but not limited to, gateways, servers, routers, workstations, mobile devices (e.g., cellular phones, tablets, smart wearable devices, etc.), Internet-of-things (IoT) devices, and a combination of any of the above example devices, and other suitable intelligent devices.

FIG. 4 is a block diagram illustrating an example computing device 400, which can be used to implement aspects of the present disclosure, and upon which one or more of the server applications, operating systems, or authentication systems described herein can be executed. Generally, FIG. 4 illustrates an example physical system useable for implementing features of the present disclosure include a general-purpose computing device in the form of a conventional personal computer.

In the example of FIG. 4, the computing device 400 includes a memory 402, a processing system 404, a secondary storage device 406, a network interface card 408, a video interface 410, a display unit 412, an external component interface 414, and a communication medium 416. The memory 402 includes one or more computer storage media capable of storing data and/or instructions. In different embodiments, the memory 402 is implemented in different ways. For example, the memory 402 can be implemented using various types of computer storage media.

The processing system 404 includes one or more processing units. A processing unit is a physical device or article of manufacture comprising one or more integrated circuits that selectively execute software instructions. In various embodiments, the processing system 404 is implemented in various ways. For example, the processing system 404 can be implemented as one or more processing cores. In another example, the processing system 404 can include one or more separate microprocessors. In yet another example embodiment, the processing system 404 can include an application-specific integrated circuit (ASIC) that provides specific functionality. In yet another example, the processing system 404 provides specific functionality by using an ASIC and by executing computer-executable instructions.

The secondary storage device 406 includes one or more computer storage media. The secondary storage device 406 stores data and software instructions not directly accessible by the processing system 404. In other words, the processing system 404 performs an I/O operation to retrieve data and/or software instructions from the secondary storage device 406. In various embodiments, the secondary storage device 406 includes various types of computer storage media. For example, the secondary storage device 406 can include one or more magnetic disks, magnetic tape drives, optical discs, solid state memory devices, and/or other types of computer storage media.

The network interface card 408 enables the computing device 400 to send data to and receive data from a communication network. In different embodiments, the network interface card 408 is implemented in different ways. For example, the network interface card 408 can be implemented as an Ethernet interface, a token-ring network interface, a fiber optic network interface, a wireless network interface (e.g., WiFi, WiMax, etc.), or another type of network interface.

The video interface 410 enables the computing device 400 to output video information to the display unit 412. The display unit 412 can be various types of devices for displaying video information, such as an LCD display panel, a touch-sensitive display panel, an LED screen, a projector, a wearable (e.g., head-mounted) display, or the like. The video interface 410 can communicate with the display unit 412 in various ways, such as via a Universal Serial Bus (USB) connector, a VGA connector, a digital visual interface (DVI) connector, an S-Video connector, a High-Definition Multimedia Interface (HDMI) interface, a DisplayPort connector, or wireless display interface, or a general-purpose wireless interface adapted for communicating display information to a compatible display device.

The external component interface 414 enables the computing device 400 to communicate with external devices. For example, the external component interface 414 can be a USB interface, a FireWire interface, a serial port interface, a parallel port interface, a wireless interface such as a WiFi, Bluetooth, or other suitable standardized or non-standard wireless interface, and/or another type of interface that enables the computing device 400 to communicate with external devices. In various embodiments, the external component interface 414 enables the computing device 400 to communicate with various external components, such as external storage devices, input devices, speakers, modems, media player docks, other computing devices, scanners, digital cameras, and fingerprint or other biometric readers.

The communications medium 416 facilitates communication among the hardware components of the computing device 400. In the example of FIG. 4, the communications medium 416 facilitates communication among the memory 402, the processing system 404, the secondary storage device 406, the network interface card 408, the video interface 410, and the external component interface 414. The communications medium 416 can be implemented in various ways. For example, the communications medium 416 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface a QuickPath interconnect (QPI), a HyperTransport connection, or other suitable type of communications medium, or combination thereof.

The memory 402 stores various types of data and/or software instructions. For instance, in the example of FIG. 4, the memory 402 may include a combination of non-volatile and volatile memory circuitry for storing Basic Input/Output System (BIOS) or Unified Extensible Firmware Interface (UEFI), referred to as BIOS 418 for simplicity, and an operating system 420. The BIOS 418 includes a set of computer-executable instructions that, when executed by the processing system 404, cause the computing device 400 to boot up. The operating system 420 includes a set of computer-executable instructions that, when executed by the processing system 404, cause the computing device 400 to provide an operating system that coordinates the activities and sharing of resources of the computing device 400. Furthermore, the memory 402 stores application software 422. The application software 422 includes computer-executable instructions, that when executed by the processing system 404, cause the computing device 400 to provide one or more applications. The memory 402 also stores program data 424. The program data 424 is data used by programs that execute on the computing device 400.

The term computer readable media as used herein may include computer storage media that is tangible and non-transitory. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program engines, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM such as flash memory, optical discs (e.g., CD-ROMs, DVDs, etc.), magnetic disks (e.g., hard disks, floppy disks, etc.), solid-state drives (SSDs), removable or portable drives, and other types of devices and/or articles of manufacture that store data.

The computing device 400 may be one physical machine, or may be distributed among multiple physical machines, such as by role or function, or by process thread in the case of a cloud computing distributed model. In various embodiments, various functions may be configured to run in virtual machines that in turn are executed on one or more physical machines. It will be understood by persons of skill in the art that features of the invention may be realized by a variety of different suitable machine implementations.

Aspects of the embodiments may be arranged in an architecture that includes various engines, each of which is constructed, programmed, configured, or otherwise adapted, to carry out a function or set of functions. The term “engine” as used herein means a tangible device, circuit, component, or arrangement thereof, implemented using hardware, such as by an application specific integrated circuit (ASIC) or field-programmable gate array (FPGA), for example, or as a combination of hardware and software, such as by a processor-based computing platform as described above, for example, and a set of program instructions that transform the computing platform into a special-purpose device to implement the particular functionality. An engine may also be implemented as a combination of the two, with certain functions facilitated by hardware alone, and other functions facilitated by a combination of hardware and software. In an example, the software may reside in executable or non-executable form on a tangible machine-readable storage medium. Software residing in non-executable form may be compiled, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

In examples where engines are temporarily configured, each of the engines may be instantiated at different moments in time. For example, where the engines comprise a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out.

In addition, an engine may itself be composed of more than one sub-engines, each of which may be regarded as an engine in its own right. Moreover, in the embodiments described herein, each of the various engines corresponds to a defined functionality; however, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

FIG. 5 illustrates an example arrangement of engines that may be implemented to produce information device 500, using the hardware environment 400 illustrated in FIG. 4. Information device 500 may be an endpoint device, such as a workstation or mobile computing device, an IoT device, or the like; a server or system of servers, or edge device such as a networking switch, router, or gateway, for instance. In one type of embodiment, as shown, the information device 500 includes a controller 502 including at least one processor 504, a power source 506, and memory 508, which can be as described above in connection with FIG. 4. In some implementations, volatile memory 510 is used as part of the computing device's cache, permitting application code and/or data to be accessed quickly and executed by processor 504. Memory 508 may also include non-volatile memory 512, as well as flash memory 514.

A file system 522 may reside as a component in the form of computer-executable instructions and/or logic within memory 508, that when executed serves as a logical interface between code stored in flash 514 and other storage mediums. File system 522 is generally responsible for performing transactions on behalf of code stored in ROM or one or more applications. File system 522 may also assist in storing, retrieving, organizing files, and performing other related tasks associated with code and/or data. That is, file system 522 has the ability to read, write, erase, and manage files (applications, etc.). File system 522 may also include other applications such as web browsers, e-mail, applications, and other applications.

Information device 500 may also include one or more Input/Output ports 516 to transmit and/or receive data. I/O ports 516 are typically connected in some fashion to controller 502 (processor 504 and memory 508). I/O ports 516 are usually at least partially implemented in hardware for connecting information device 500 to a communication link 518, and may include wired as well as wireless capabilities. Communication link 518 may include any suitable connection means for handling the transportation of data to and from information device 500, such as, but not limited to, cable, fiber optics, and wireless technology. Communication link 518 may also include network technology including portions of the Internet.

Stored within one or more portions of memory 508 is a security engine 550. That is, security engine 550 includes one or more sets of computer-executable code resident in a computer-readable medium such as memory 508. Security engine 550 performs security functions associated with transmitting, receiving, or storing data. These security functions may include encrypting data and decrypting data. Typically, cryptographic asymmetric key pairs are installed in non-volatile memory 512. However, it is appreciated that a corresponding cryptographic key may reside on another computing device.

In one embodiment, security engine 550 includes one or more filters 552, which define permissions relating to secure communication by information device 500. By permissions, it is intended that one or more remote endpoints can be defined in a filter, and access to that endpoint can be either allowed or prevented based on an identity of a user, an identity of a machine, or on a combination thereof.

In such an embodiment, security engine 550 also includes one or more COI keys 554, which are private and secret keys used for encrypting/decrypting other security keys in accordance with this invention. That is, COI keys 554 are used for transformation (encryption) of a second key (or additional keys), such as a session key, into a cryptographically split key, as well as for retransformation (decryption) of the second key back to its usable form.

A COI key 554 refers generally to an encryption key and/or corresponding decryption key, that may be assigned to an endpoint device of an end-user based on an associated COI attributed to the end-user. For instance, end-users of an information device 500, may also have one or more COI keys 554 installed on their computing device, based on their position or security level within an organization.

It is also possible to secure and segregate messages based on a category of a COI associated with the message using a corresponding COI key 554 (e.g., cryptographic pairs). Also, unlike private/public key pairs, COI keys 554 are usually installed or generated before a transaction to increase security, rather than receiving and generating the key on-the-fly during a transaction, in which the key can be intercepted. COI keys 554 may be stored in a key repository 566, which is a storage area in memory 508. Filters 552 can also be stored in memory 508.

In some embodiments, each COI key 554 has an associated filter 552, such that a set of endpoint access permissions are included with each community of interest. In such embodiments, the filter is associated with a COI key 554. Example community of interest keys can include a secure community of interest key 554, that may have an associated filter defining one or more endpoints and/or gateway devices associated with that community of interest and excluding communication with any unsecured sites, or a clear text filter that would allow clear text communication with external, publicly available and unsecured systems (e.g., via the internet). In the example of the clear text filter, such a filter could include one or more exclusionary permissions preventing clear text communication to secured endpoints or gateway devices normally requiring cryptographically-secured communication. Additional details regarding example key and filter arrangements are discussed below in conjunction with FIG. 17-21.

Security engine 550 may also include a cryptographic engine 556 for generating cryptographic keys and other information used to encrypt or decrypt messages, as well as route data to a target device. In one embodiment, cryptographic engine 556 generates a cryptographic data set, which may include one or more session keys which are used for encrypting/decrypting one message or a group of messages when information device 500 is in a communication session with another device.

Security engine 550 may also include other authentication data and code 558, used for purposes of authenticating data or information, such as passwords, recorded biometric information, digital certificates, and other security information. As is appreciated by those skilled in the art after having the benefit of this disclosure, it is possible that there may be various combinations of keys and authentication data in security engine 550.

Portions of security engine 550 may be communicatively coupled to each other through controller 502. As would be appreciated by those skilled in the art, some of the components of security engine 550 may be stored and identified as files under control of file system 522.

Security engine 550 may also include a data splitter engine 560 for splitting data that is to be transmitted from information device 500. Typically, security engine 550 relies on a COI key and/or cryptographic engine 556 to determine how to split and encrypt data. Data splitter engine 560 divides data into portions of data. A portion of data is any bit or combination of bits of data that comprise a larger set of data, such as a message or a portion of a cryptographic data set (a second key). A portion of data may be encapsulated in packets for transport, but the content of the data may be fixed or of a variable bit length. Accordingly, a portion of data (such as a portion of message or portion of cryptographic data set) corresponds to one or more bits comprising data content, i.e., payload as opposed to a data header message. Data splitter 560 may be configured to produce predetermined bit length portions of data or it may be determined dynamically in an automatic fashion.

Security engine 550 may also include an assignment engine 562. Assignment engine 562 assigns tags to each portion of data (portion of a message or key). Each tag contains metadata indicating a traffic path through which a particular portion of data is to be distributed via one or more networks to another computing device 400. Other metadata may be included in the tags, such as information identifying the network the portion of data originated from, the client device destination, possibly the order of the portion of data in relation to other portions of data emitted from the same network, and other suitable information.

Security engine 550 may also include an assembler engine 564 configured to reassemble portions of data received at different times, and/or via different data paths. Once data is reassembled, authorized assets and messages appear accessible in plaintext format from the end-users perspective. It is noted that various security techniques may be employed on information device 500 to prevent the user from saving data, mixing different levels of data, or sending the data to other locations for dissemination to another network, such as via email or other electronic transfer means. Applications may also execute on separate physical and/or logical partitions within information device 500.

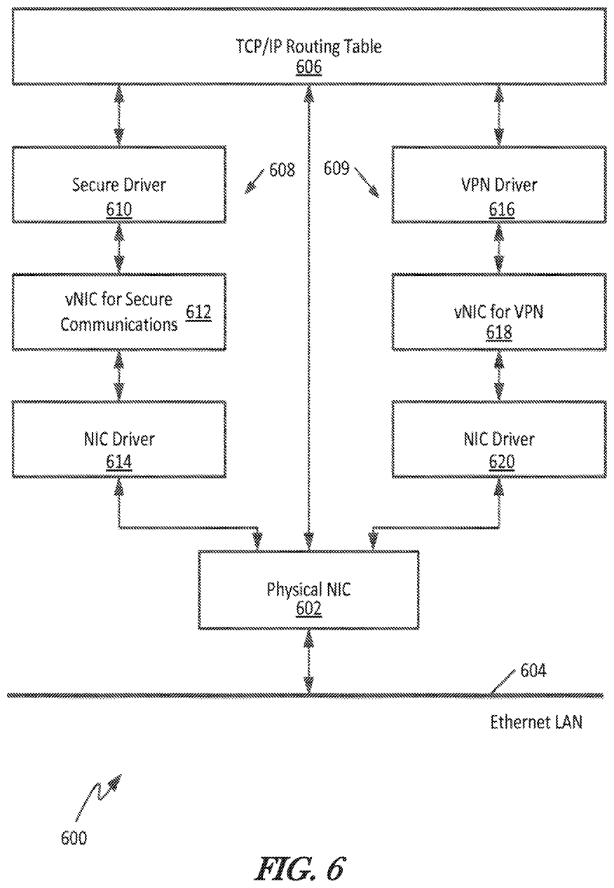

FIG. 6 illustrates an example communications infrastructure 600 useable within a computing environment to manage both secure and clear text communications channels, according to various aspects of the present disclosure. The communications infrastructure 600 can be implemented within the computing systems 400, 500 of FIGS. 4-5, for example using the operating system 420, application programs 422, and program data 424 to manage the operation of network interface or adapter 408 of FIG. 4, and, for example, as at least in part implemented using security engine 550 of FIG. 5.

In the embodiment shown, the communications infrastructure 600 includes a physical network interface card 602 communicatively interconnected to a network 604, illustrated in this example as an Ethernet local area network (LAN). The physical network interface card 602 is generally a piece of communications hardware included within the computing system, and can be, in one embodiment, the network interface adapter 452 of FIG. 4. In other examples, the physical network interface card 602 may be a wireless network interface circuit including, for instance, WiFi or Bluetooth radio circuitry.

The communications infrastructure 600 includes a routing table 606, which defines one or more local and remote IP addresses used to communicate messages between a computing system incorporating the infrastructure 600 and a remote computing system. For example, the routing table 606 can include a default route, local network and broadcast addresses, as well as one or more network masks, gateways, and other points of interest.

In general, when a computing system intends to transmit clear text data using the physical network interface card 602, that system will determine an address using the routing table 606 and form a packet to be forwarded to the physical network interface card 602 for communication via network 604. In accordance with the present disclosure, to separate secure data communications from standard clear text communications, a dedicated communication stack can be used for each of one or more types of secured communication. In this aspect, each dedicated communication stack may be considered as a virtual communication channel.

In the embodiment shown, and as discussed in further detail in various embodiments of the present disclosure below, the communications infrastructure 600 includes a first secure software stack 608 and a second secure software stack 609, each useable to communicate over a secured connection to a remote system. The first secure software stack 608 that includes a secure communications driver 610, a virtual secure network interface card 612, and a network interface card driver 614.

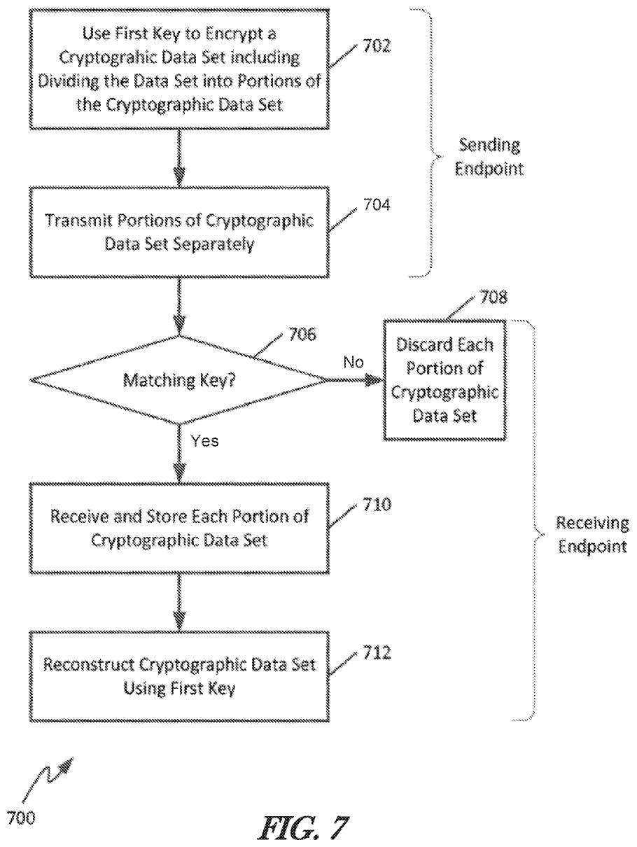

The secure communications driver 610 receives data to be transmitted via a secured communication method (e.g., as described in FIGS. 7-9, below), and an address from the routing table 606, and generates one or more packets of encrypted data to be transmitted. In some embodiments, as discussed further below, a secure communications driver uses one or more filters to determine whether secured (split and encrypted) data packets can be sent or received to/from a particular network address, and to determine whether secure or clear text data packets can be accepted at the computing system implementing the communications infrastructure 600. In other embodiments, firewall at the application layer are applied to carry out the filtering. For example, if a data packet or message is received at the virtual secure network interface card 612 from an endpoint not included in an access list of a filter that defines permissions to that endpoint or client device, the secure communications driver 610 (or firewall) will discard that packet, preventing it from reaching an application to which it would otherwise be addressed or intended. Likewise, the secure communications driver 610 or applicable firewall rules can prevent communication of data packets to remote endpoint systems not authorized by the access lists in one or more filters defined in the computing device.

The virtual secure network interface card 612 acts as a virtual version of the physical network interface card 602, in that it receives data packets formed at the secure communications driver 610 and instructions for where and how to transport those data packets. In certain embodiments, the secure communications driver 610 acts analogously to a hardware driver, but acts on the virtual secure network interface card 612.

The network interface card driver 614 provides the link between the virtual secure network interface card 612, and physical network adapter 604 to allow communication of secured data packets with a remote system (e.g., an endpoint, gateway, or other remote system). In certain embodiments, the network interface card driver 614 acts as a piece of hardware to the operating system of the computer implementing the communications infrastructure 600, for example to host the virtual secure network interface card 612, and allow applications to transmit data via that piece of virtual hardware.

In the embodiment shown, an optional second software stack 609 is also shown, which can be used concurrently with the first secure software stack 608. In the embodiment shown, the second software stack is configured to allow a different type of security, in which security is not provided by data obfuscation on a packet-by-packet basis, but rather by creating a secured connection to a dedicated endpoint. In the example embodiment shown, this second software stack 609 is configured to manage communication via a virtual private network (VPN) connection, where a secure tunnel is formed between the computing system operating the communications infrastructure 600 and a predetermined, known gateway. In this embodiment, the second software stack 609 includes a VPN driver 616, a virtual VPN network interface card 618, and a VPN communications driver 620. The VPN driver 616 generates instructions for communication with a particular VPN gateway, and for constructing a secure tunnel between the computing system implementing the communications infrastructure 600 and the VPN gateway (e.g., as illustrated below in connection with FIG. 6). The virtual VPN network interface card 618, like the virtual secure network interface card 612, acts as a virtual version of the physical network interface card 602, in that it receives data packets formed at the VPN driver 616 and instructions for where and how to transport those data packets (e.g., via a secure tunnel). The virtual VPN network interface card 618, similar to the network interface card driver 614 acts as a piece of hardware to the operating system of the computer implementing the communications infrastructure 600, for example to host the virtual VPN network interface card 618, and allow applications to transmit data via that piece of virtual hardware to remote systems.

Overall, and referring to FIGS. 1-6 generally, it is noted that the computing systems and generalized example networks of the present disclosure generally provide infrastructure for receipt and management of encryption keys specific to one or more communities-of-interest, and distributed use of algorithms for encrypting and splitting data into obscured data packets such that only those individuals having access rights to that data can in fact reformulate the data upon receipt of those data packets. FIGS. 7-9 below briefly describe methods and arrangements for treatment of data packets sent and received from a gateway, endpoint, or other computing device configured for secured communication using the cryptographic splitting and virtual network arrangements of the present disclosure.

### II. METHODS FOR SECURE COMMUNICATION

Referring now to FIGS. 7-9, methods and systems for securely transmitting data packets between computing systems are disclosed. Generally, the methods and systems illustrated in FIGS. 7-9 provide a brief overview of methods of handling data packets sent and received using the computing systems and networks described herein, for example those discussed above with respect to FIGS. 1-6.

As used herein, a “message” or “data packet” refers generally to any set of data sent from one node to another node in a network. A message may include different forms of data usually in some form of a payload. A message may be an e-mail, a video stream, pictures, text documents, word processing documents, web-based content, instant messages, and various other forms of data that when in plain text, or clear form, may reveal confidential and sensitive information. In most instances, this invention is concerned with securing data-in-motion, or in other words, cryptographic data or messages sent from one node to another node such as data traveling from one location to another within one or more networks which may include the Internet.

FIG. 7 illustrates an exemplary method 700 for securely transmitting a cryptographic data set among logically partitioned data paths. The cryptographic data set can include, for example one or more encryption keys, filters, and other information useable at an endpoint or other computing device to enable that device to establish secure communication with a remote system (e.g., another endpoint, a gateway, or any other remote device configured for cryptographically split communication).

In this method, in block 702, a cryptographic data set is divided into a plurality of portions, and tag values are assigned to each portion of the set. Each portion is encapsulated in separate packets. In block 704, the portions of cryptographic data set are transmitted from an egress point of a computing device, such as a network interface card as discussed above in conjunction with FIG. 6. On the receiving endpoint, in block 706, each portion of cryptographic data is received by a target computing device. In one embodiment, as the packets received include a new COI key identifier embedded therein. In another embodiment, newly received packets do not include such a key identifier, and instead the receiving endpoint attempts to restore (reassemble) a cryptographic data portion encapsulated in a payload portion of the packet using a COI key accessed from the receiving computing device's repository. If there is only one COI key present in the repository, the receiving computing will attempt to reassemble the cryptographic data portion(s) using the single key. If there are more than one COI key in the receiving computing device's repository, the receiving computing device will iteratively try each key until it locates a key which is able to reassemble the cryptographic data portion(s).

However, if no identifier match is located in block 706, in block 708 each packet and hence portion of cryptographic data set received by the target device is discarded, erased, and/or ignored. This may represent a situation where the end-user of an endpoint does not have authorization to view a message, because the end-user (or the end-user's computing device) lacks the requisite COI key, or if the transmitting computing device is not included in a listing of permitted devices at the target device.

If according to the Yes branch of block 706, a COI key matching the identifier is located, or a COI key is identified which is able to restore the payload portion of the packet(s), then in block 710 each portion of the cryptographic data set is temporarily stored for eventual reassembly. At this point a tunnel can be established between the sending and receiving computing devices.

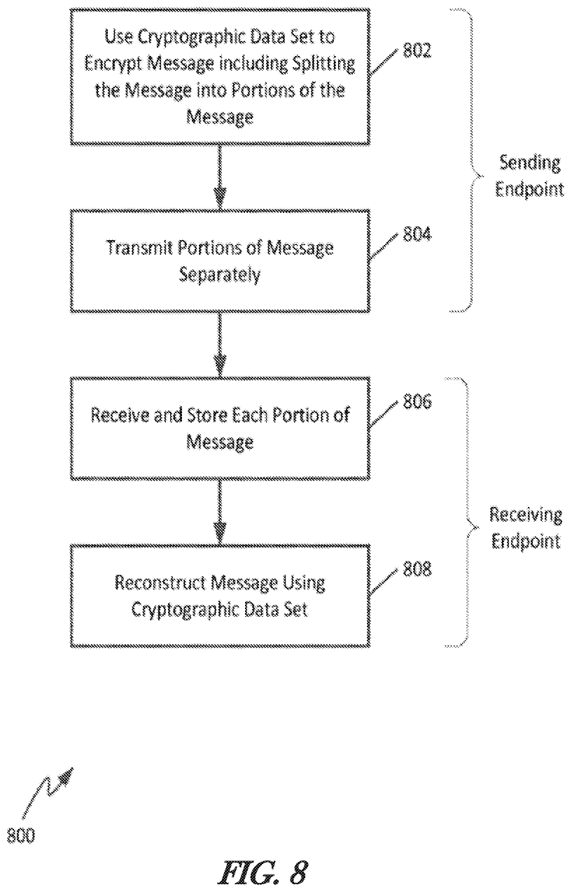

In block 712, the cryptographic data set is decrypted. That is, the cryptographic data set is reconstructed (reassembled) by decrypting each portion of the cryptographic data set using the COI key identified in block 710. Once all portions of cryptographic data set are received, it is possible to fully reassemble the cryptographic data set on the receiving computing device. The cryptographic data set is in a usable form for use to decrypt portions of a message received, which will be described with reference to FIG. 8.

FIG. 8 illustrates an exemplary method 800 for securely transmitting a message among logically partitioned data paths, according to a possible embodiment. Generally, method 800 occurs after a secure tunnel has been created, to allow transmission between two computing systems. Method 800 includes blocks 802, 804, 806, and 808 (each of the blocks represents one or more operational acts). The order in which the method is described is not to be construed as a limitation, and any number of the described method blocks can be combined in any order to implement the method. Furthermore, the method can be implemented in any suitable hardware, software, firmware, or combination thereof.

In block 802, a message is divided into portions, and tag values are assigned to each portion of the set. Each portion is encapsulated in separate packets using a cryptographic data set at the sending computing device. For example, in one embodiment, an assignment engine 562 (FIG. 5) uses a cryptographic data set stored at the sending computing device (or as received, according to the method 700 of FIG. 7) to assign tags to each portion of the message. Each tag contains metadata indicating a traffic path a particular portion of a message is to follow to a target computing device within a network.

In block 804, the portions of cryptographic data set are transmitted from an egress point of a computing device. For example, portions of cryptographic data set are transmitted from an I/O port 516 of information device 500, separately. In one embodiment, transmitting the portions separately may include transmitting at least one portion of the message at a different instance in time than at least another portion of the message. In one embodiment, transmitting the portions of the message separately includes transmitting at least two different portions of the message on at least two different data communication paths. For example, information device 500 assigns a portion of message to a particular data path based on the tag value. Tag values assigned to each portion of cryptographic data may correspond to a particular communication data path, to transmit the portion of cryptographic data set. In block 806, each portion of the message set is temporarily stored for eventual reassembly in some portion of memory 508 (FIG. 5) of a computing device.

In block 808, the message is put into a useable form. That is, the message is reconstructed (reassembled) by decrypting each portion of the message using the cryptographic data set. For example, security engine 550 (FIG. 5) may use an assembler engine 564 (FIG. 5) in conjunction with a cryptographic data set to reassemble portions of message received at different times, and/or via different data paths. Once all portions of the message are received, it is possible to fully reassemble the message in a usable form on the receiving computing device.

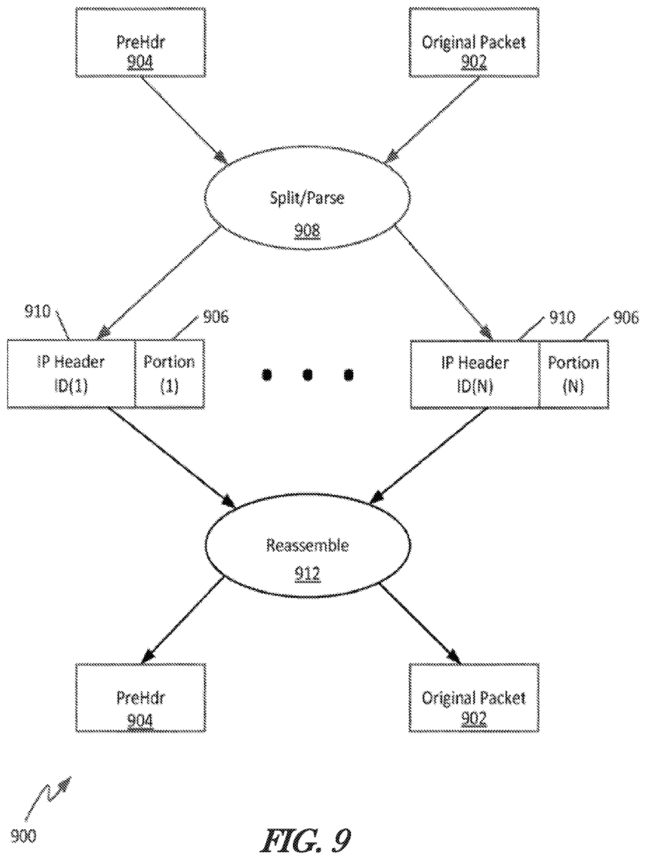

FIG. 9 illustrates an overall logical flow of how an original message or cryptographic data set (e.g., as in FIGS. 7-8, above) is split and encrypted according to the various embodiments discussed herein. As illustrated, an original message 902 is combined with a preheader 904, and split into portions 906 by a splitting function 908. The splitting function 908 also acts to encrypt each of the portions, such that each portion contains an obfuscated portion of the original message 902. Each of the portions 906 are appended with an IP header 910. The IP header 910 of each split portion identifies the set of data to which the portion 906 belongs. The various portions can then be passed from a first computing system to a second computing system via a number of different routes, with the second computing system having a capability of reassembling that original message 902 (for example, due to possession of a complementary COI key or cryptographic data set) at a reassembly function 912. In various embodiments, the splitting function 908 and reassembly function 912 can be performed, for example, by a security engine, such as engine 550 of FIG. 5, on an authorized transmitting and receiving computing device, respectively. In certain embodiments, the splitting function 908 and reassembly function 912 use a strong encryption standard, such as AES-256 encryption. Other types of encryption standards and data splitting/dispersal operations could be used as well.

### III. ENDPOINT ISOLATION IN THE SECURE COMMUNICATIONS CONTEXT

A related aspect of the embodiments is directed to secure isolation of an endpoint from other endpoints to which the endpoint would normally have cryptographically-segmented connections, while maintaining administrative control over the isolated endpoint's access privileges, connections, and security-related functionality. Notably, the isolation state is not a state where an endpoint is merely denied access to its usual connections. In addition to being separated from its usual operational-state connections, the isolated endpoint is connected to one or more cryptographically-segmented connections to one or more isolated entities (e.g., server, peer endpoint). Isolation of the endpoint results in the endpoint closing any open tunnels, receiving the COI configuration defined by the isolation role, and then using that COI configuration when opening any tunnels available to the isolation role. An endpoint's transition to an isolated state may be independent of any credentials used to authenticate the endpoint in the cryptographically-segmented network.

According to various examples, isolation of an endpoint is initiated, (re)configured, and concluded, via application programming interface (API) calls to an enterprise manager engine from an administrator interface. In related embodiments, isolation state changes for an endpoint (e.g., initiation, reconfiguration, conclusion) is effected via API calls. In other related embodiments, the isolation state changes are effected exclusively via API calls. In placing an endpoint into an isolated state, the isolation role may be chosen from a set of predefined isolation roles. Once isolated, the endpoint remains in that isolated state, regardless of endpoint state changes (e.g., reboots, power cycles, etc.) until another API-based isolation control command is issued. Isolation control command can include commands to move the endpoint to a different isolation role, or to reinstate (conclude isolation).

In various embodiments, the isolation technique provides a solution for logically moving an endpoint suspected of having been compromised to a role that isolates that endpoint to a predefined maintenance-only network that is removed from any data-center operational networks. From the maintenance network the isolated endpoint can be remotely probed or reconfigured, e.g., to determine its current security, operational, or other condition, malware scanning can be performed, and, if called for, the endpoint's configuration can be rebuilt. Once the endpoint has been determined to be clean, the endpoint may be returned to the data center's operational networks.

Additionally, the isolation technique facilitates running forensics against a suspect endpoint. For instance, an endpoint may be assigned to a role within the cryptographically-segmented network that provides access to a set of one or more honeypot systems, thereby emulating a network environment with peer endpoints. Any malicious software running on the suspect endpoint is therefore presented with a network environment that appears like a normally-deployed system, allowing the progress of any malicious software on the target machine to be observed. Once the forensic observation is complete, the endpoint may be moved to a maintenance-only network to clean the endpoint before allowing the endpoint to reinstate its normal access to the data center's operation networks.

In various embodiments, an endpoint may be isolated while in a running (online) or offline state. In addition, an isolated endpoint's isolation role may be adjusted. For instance, an endpoint may be isolated to a second isolated COI from a first isolated COI. Endpoints may be identified for isolation by machine ID or by User ID. In addition, an endpoint isolated by machine ID may have its isolation role adjusted by addressing the endpoint by user ID, and vice-versa.

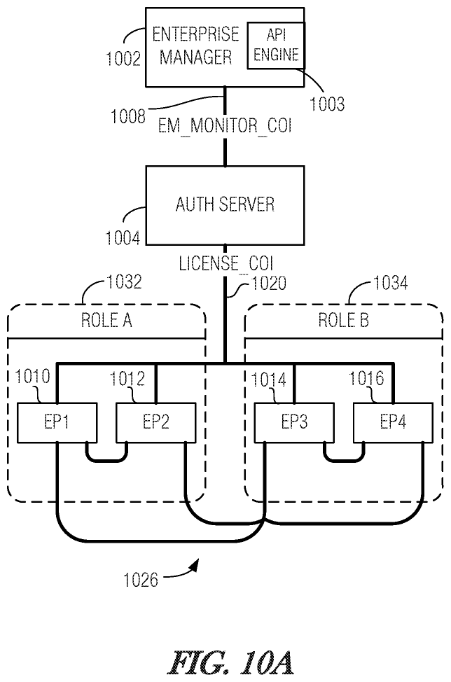

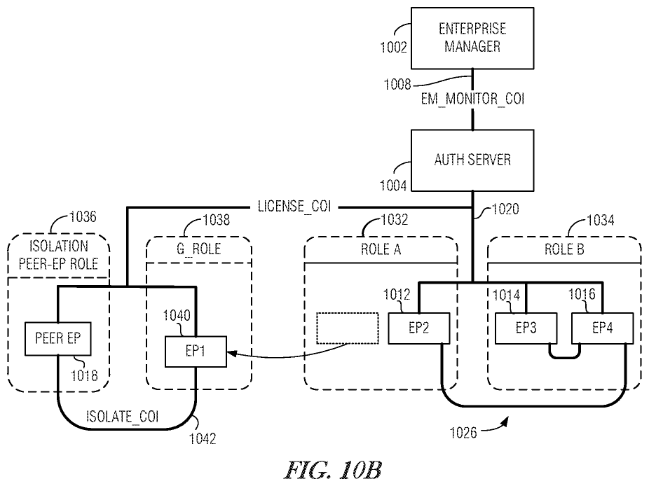

FIG. 10A is a block diagram illustrating an example architecture of a cryptographically-segmented network according to aspects of the present subject matter. In the example depicted, the cryptographically-segmented network is configured to support isolation of endpoints; however, in the operational state shown in FIG. 10A, no endpoints are currently isolated. The system architecture in this example includes enterprise manager 1002, authentication server 1004, and endpoints 1010, 1012, 1014, and 1016. Each of these entities may be implemented as an engine on a distinct computing platform. In some embodiments, more than one of the engines may be implemented on a shared computing platform. For example, enterprise manager 1002 and authentication server 1004 may be implemented together on a common computing platform.

Enterprise manager 1002, authentication server 1004, and endpoints 1010-1016 are communicatively coupled, as shown, via the cryptographically-segmented network. Accordingly, enterprise manager 1002 has a virtual communication channel established with authentication server 1004, and defined in accordance with the COI indicated as EM_MONITOR_COI 1008. Authentication server 1014, in turn, has a virtual communication channel defined in accordance with the COI indicated as LICENSE_COI 1020, over which to communicate securely with endpoints 1010-1016. The virtual communication channels associated with COIs 1008 and 1020 are cryptographically-segmented networks that may be implemented in accordance with communications infrastructure 600 described above with reference to FIG. 6, and the secure communication methods described above with reference to FIGS. 7-9.

Enterprise manager 1002 maintains a database, file system, list, extensible-markup-language (XML) file, or other suitable data representing the endpoints 1010-1016, their associated user accounts, assigned COI roles, and other information pertinent to managing the various authorizations of the endpoints. In addition, enterprise manager 1002 may maintain and apply rules or configuration parameters in accordance with various policies (e.g., global, user-specific, COI-specific, endpoint-specific) such as access-related policies or security-related policies. Enterprise manager 1002 may include API engine 1003 that is configured to accept API calls from authorized entities (e.g., administrator user accounts, security-services provider user accounts, etc.) relating to management of endpoints 1010-1016, including initiating, reconfiguring, and concluding isolation of the endpoints. In some implementations, enterprise manager 1002 maintains an isolation list (e.g., database, xml file, etc.) of endpoints that are, or are to be, isolated. In addition, enterprise manager 1002 may include a monitoring engine (not shown) that receives information regarding the status or activity of endpoints 1010-1016 via EM_MONITOR_COI 1008 from authentication server 1004.

Authentication server 1004 receives endpoint-specific settings via EM_MONITOR_COI 1008 from enterprise manager 1002, handles authentication and licensing of endpoints, including secure cryptographic key distribution and revocation other access-related functionality via LICENSE_COI 1020, and maintains records of endpoints 1010-1016 with which communication sessions in the cryptographically-segmented network are in progress. Accordingly, authentication server 1004 authenticates endpoints (e.g., by machine ID or user ID and suitable access credential) via LICENSE_COI 1020. Examples of access credentials include asymmetric key, symmetric key, one-time password (OTP), attribute-based encryption, etc., or some combination of techniques). Authentication server 1004 may distribute COI keys to authenticated endpoints over LICENSE_COI 1020.

In addition, authentication server 1004 may monitor the status, configuration, and operations of endpoints 1010-1016 via LICENSE_COI 1020 and report this information to enterprise manager 1002 via EM_MONITOR_COI 1008.

As depicted in this example, endpoints 1010-1016 are each assigned to either ROLE A 1032 or ROLE B 1034. Each role represents a corresponding COI. In addition, endpoints 1010-1016 may belong to one or more other inter-role COIs 1026. The role and other COI assignments are defined and managed via enterprise manager 1002, and administered by authentication server 1004.

FIG. 10B is a diagram illustrating the cryptographically-segmented network of FIG. 10A with endpoint EP1 having been isolated as indicated at 1040. In this example, the isolation configuration calls for additional isolation-specific roles to be established. As shown, ISOLATION PEER-EP ROLE 1036, and global isolation role G ROLE 1038 are defined. Endpoint EP1, indicated with reference numeral 1040, is now reconfigured to belonging in the global isolation role G ROLE 1038. As will be described in greater detail below, in accordance with receiving an isolation command, endpoint EP1 closes any open tunnels and deletes its operational COI configuration. The endpoint then activates its isolation role COI configuration. In the embodiment shown, isolated endpoint EP1 1040 is additionally assigned to isolation COI 1042, which enables a virtual communication channel between isolated endpoint EP1 1040 and peer endpoint 1018.

Peer endpoint 1018 facilitates monitoring of the operations of endpoint EP1 1040 and further facilitates remote access to isolated endpoint EP1 via isolation COI 1042. In various examples, peer endpoint 1018 includes security engines to scan and clean isolated endpoint EP1 1040 under the ultimate control of enterprise manager 1002.

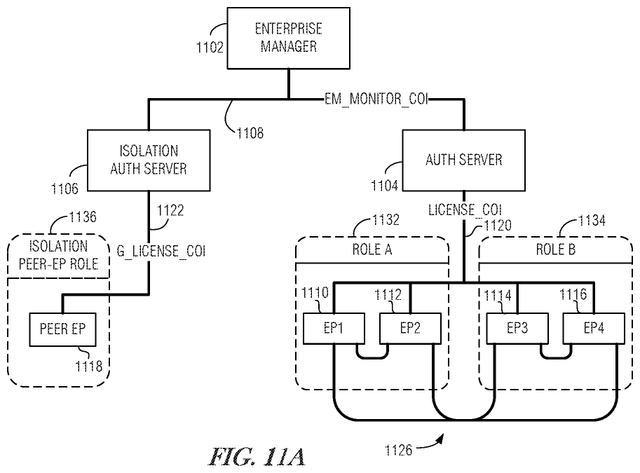

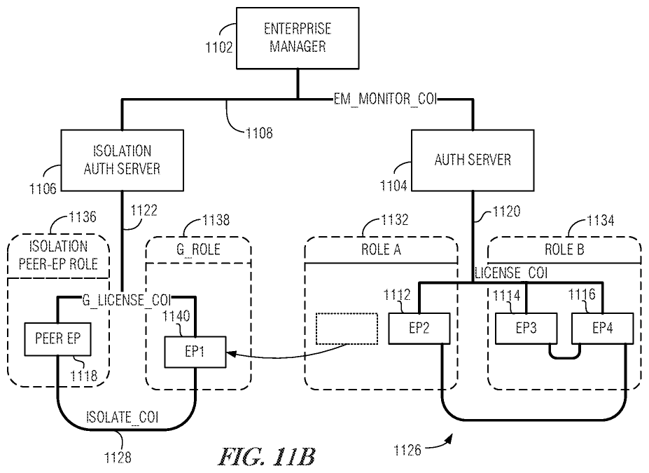

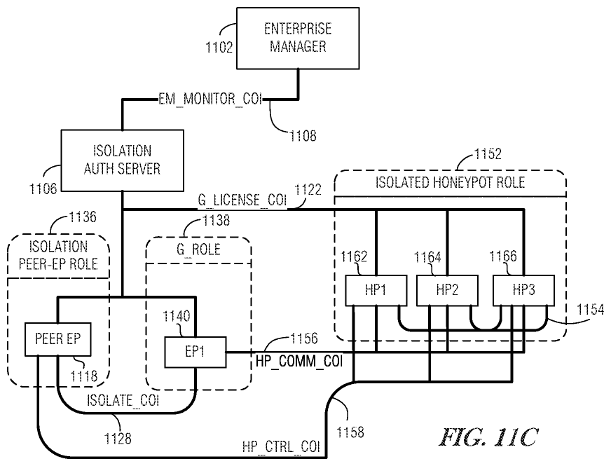

FIGS. 11A-11B are diagrams illustrating a related architecture of a cryptographically-segmented network that supports endpoint isolation, according to some embodiments. With reference to FIG. 11A, as depicted, enterprise manager 1102 is similar to enterprise manager 1002 except that in the embodiment of FIG. 11A enterprise manager 1102 communicates with isolation authentication server 1106 via EM_MONITOR_COI 1108. Authentication server 1104 is substantially similar to authentication server 1004, except that authentication server 1104 does not support isolated endpoints. Authentication server 1104 carries out commands to effect isolation, but once the usual-operation COI keys of an endpoint being isolated are disabled, authentication server 1104 remains isolated from the isolated endpoint. LICENSE_COI 1120 is similar to its counterpart in FIGS. 10A-10B, as are Roles A and B 1132, 1134, endpoints 1110-1116, and inter-role COIs 1126.

Isolation authentication server 1106 is configured to facilitate control, testing, servicing, malware scanning and removal, isolation configuration adjustment, and conclusion of isolation of isolated endpoints. Isolation authentication server 1106 receives isolation commands, policy information, and configuration information from enterprise manager 1102 via EM_MONITOR_COI 1108, and sends monitored status, configuration, and operational data about isolated endpoints to enterprise manager 1102 via EM_MONITOR_COI 1108. Isolation authentication server 1106 is further configured to establish global license COI (indicated as G LICENSE_COI) 1122 and isolation peer-endpoint role 1136, both of which peer endpoint 1118 is a member.

In one embodiment, isolation authentication server 1106 maintains a list or other suitable data structure of isolated endpoints (e.g., by endpoint machine ID). In a related embodiment, isolation authentication server 1106 maintains a list or other suitable data structure of isolated user accounts (e.g., by user ID). Isolation authentication server 1106 may further access user account-endpoint associations from which it may determine the endpoints to be isolated, reinstated, or have its isolation role changed.

In operation, according to an example implementation, API commands are used to initiate isolation of an endpoint. In some embodiments, the API commands make method calls to a service facilitated by enterprise manager 1102, to initiate a change in the isolation settings for an endpoint. An authorization enforcement mechanism may be utilized to ensure that the API calls are made by an entity having sufficient privileges to perform the call, such as Portal Administrator. Parameters to the API call may include a target (an endpoint machine ID or a user ID), a reference to the isolation role (e.g., Global Isolation Role) that the endpoint is to be isolated to, and the uniform resource identifier (URI) of the isolation authentication server that is to be used to monitor and manage the endpoint while it remains isolated. Enterprise manager 1102 maintains a list of those targets (endpoints or users) that have been isolated. Enterprise manager 1102 processes the information received via the API, either adding or updating the list of isolation targets to a maintained master list and creating or updating an instance of the a new isolation information object that maintains the attribute values for an isolated target (either a machine ID or a user ID).

In a related embodiment, latency between the request to isolate an endpoint (or user account) and when that endpoint (or user account) is moved to the isolation role, the isolation information is pushed out as each function call is made. Notably, multiple targets, machine ID endpoints or user IDs, can be specified in a single function call.

In an example implementation, upon an API request for an isolation settings change (addition, modification, or deletion), enterprise manager 1102 updates its master list of endpoint status and creates a status description object, such as an XML file, for instance, that represents the updated isolated endpoints or user accounts. The XML file is sent to isolation authentication server 1106 for its retention and action. The XML file in this example includes an element that defines all machine ID indicators for endpoints that are to be, or are currently, isolated and a child element that defines the isolation environment or configuration for that endpoint. For example, the information contained in the XML file may include the Isolation Global Role ID, a set of isolation authentication group URIs (one or more), and a set of isolation authentication types (e.g., 1:1 mapping to isolation authentication group URIs). The XML file is delivered to a global method on both isolation authentication server 1106 and authentication server 1104.

FIG. 11B illustrates an example architecture of the cryptographically-segmented network of FIG. 11A when an endpoint is isolated. In this example, the isolation configuration calls for global isolation role G ROLE 1138 to be established. Endpoint EP1, indicated with reference numeral 1140, is reconfigured to belonging in the global isolation role G ROLE 1138. In accordance with receiving an isolation command, endpoint EP1 closes any open tunnels and deletes its operational COI configuration. The endpoint then activates its isolation role COI configuration. In the embodiment shown, isolated endpoint EP1 1140 is additionally assigned to isolation COI 1128, which enables a virtual communication channel between isolated endpoint EP1 1140 and peer endpoint 1118.

Isolation authentication server 1106 may further implement a monitoring engine that logs the behavior of endpoints subject to licensing by isolation authentication server 1106. The XML file may be passed to the monitoring engine to establish monitoring of those endpoints. To enable monitoring of isolated endpoint EP1 1140, the isolated endpoint EP1 opens a tunnel to isolation authentication server 1106. For example, cryptographic keys may be exchanged between the isolated endpoint EP1 1140 and the isolation authentication server 1106 that is to service the endpoint. Isolated endpoint EP1 1140 uses the COI configuration related to the COI that will be used by this tunnel, G LICENSE_COI 1122, and the isolation authentication server's public signing key. Accordingly, isolation authentication server 1106 receives the set of session keys from the endpoint, one for encryption, and a signing key to complete the configuration.

If, with the isolate command, endpoint EP1 1140 is given the URI of authentication server 1106 (or list of other available authentication server URIs) to be used while the endpoint is isolated, then endpoint EP1 obtains the session public key of the isolation authentication server 1106 that it is going to attempt to open a session to.

According to an illustrative example, in the process of isolating endpoint EP1, the endpoint is provided its assigned isolation global role COIs and filters and the URI of the isolation authentication server 1106, with which the endpoint is to maintain an open session. The session with the isolation authentication server 1106 facilitates logging, monitoring, and licensing operations.

FIG. 11C is a block diagram illustrating an example of an endpoint isolation configuration utilizing honeypot endpoint devices according to some embodiments. The configuration of enterprise manager 1102, isolation authentication server 1106, peer endpoint 1118, isolated endpoint 1140, in their respective roles and with their respective COI membership, are substantially as described above with reference to FIG. 11B, except that the isolation configuration includes isolated honeypot role 1152, and honeypot endpoints HP1, HP2, and HP3 are provided at 1162, 1164, and 1166, respectively. Honeypot endpoints are authenticated, licensed, and configured via isolation authentication server 1106 and global license COI 1122 alongside isolated endpoint EP1 1140 and peer endpoint 1118. However, the honeypot endpoints HP1-HP3 are monitored and controlled through peer endpoint 1118 via honeypot control COI 1158, marked HP CTRL COI, which is a separate virtual channel from ISOLATE COI 1128 over which isolated endpoint EP1 1140 is monitored and controlled by peer endpoint 1118. Each of the honeypot endpoints HP1-HP3 is communicatively coupled to isolated endpoint EP1 1140 via another COI, namely, honeypot communication COI indicated as HP COMM COI 1156.

### IV. ENDPOINT ISOLATION OPERATIONAL SCENARIOS

The following operational scenarios detail endpoint isolation, reinstatement, and change of isolation role according to various use cases for further illustration.

A. Isolate an Offline Cryptographically-Segmented-Network-Enabled Endpoint by Endpoint Machine ID

An endpoint is cryptographically-segmented network enabled, authenticated, and active when the isolate by endpoint machine ID command is issued. The endpoint is added to the list of isolated endpoints in the enterprise manager and the isolate command is forwarded to all authentication servers. The authentication servers add the endpoint machine ID to their list of isolated endpoints and scan their current session list for any endpoint machine ID matches. For all sessions where a match is detected, the authentication server that authenticated the endpoint sends the endpoint an asynchronous isolate command and closes the session to that endpoint. The isolate command has, as parameters, an isolation authentication server URI and the COI configuration for the isolation role that the endpoint is to move to. The endpoint being isolated closes any open tunnels and deletes the operational COI configuration. The endpoint then activates the isolation role COI configuration and issues a <tuples> request to the isolation authentication server to establish a session with the isolation authentication server. The isolation authentication server recognizes that the endpoint machine ID from the <tuples> request is from an endpoint in the isolated endpoints list and that it is the Isolation authentication server. It issues the <tuples> response to the endpoint, opening a session with this endpoint, marking the session as isolated (ignore user ID), and providing the endpoint with a new session ID and the isolation role COI configuration. The endpoint recognizes that its active COI configuration has the same hash as the ‘new’ isolation role COI configuration from the <tuples> response, therefore there is no need to close and discard the active COI configuration (e.g., Smart Rekey).

B. Isolate an Offline Cryptographically-Segmented-Network-Enabled Endpoint by Endpoint Machine ID

An endpoint is not Cryptographically-segmented network enabled, not authenticated, when the isolate command is issued. The endpoint machine ID is added to the list of isolated endpoints in the enterprise manager and the isolate command is forwarded to all authentication servers. The authentication servers add the endpoint machine ID to their list of isolated endpoints and scan their current session list for any endpoint machine ID matches. No matches will be found in this scenario. When an authentication server receives a <tuples> request to authenticate, and the endpoint machine ID matches an ID in the authentication server's list of isolated endpoints, then the authentication server-AuthGroup determines it is not the Isolation authentication server, so the authentication server-AuthGroup provides the isolation role COI configuration and isolation authentication server URI, but no session ID in the <tuples> response, and terminates the session. The endpoint responds by closing the service COI tunnel to the authentication server, loading the isolation role COI configuration and issuing a <tuples> request to the isolation authentication server to open a Cryptographically-segmented network session with the isolation authentication server. The isolation sequence completes as described above in A.

C. Isolate a Running Cryptographically-Segmented-Network-Enabled Endpoint by User ID

An endpoint is cryptographically-segmented-network-enabled and authenticated, when the isolate by user ID command is issued. The User ID is added with its associated isolation global role, along with the isolation authentication server URI, to the list of isolated users in the enterprise manager and the isolate command is forwarded to all authentication servers. The authentication servers add the user ID along with its associated isolation global role and isolation authentication server URI to their list of isolated users and scan their current session list for any user ID matches. For all sessions where a match is detected, the endpoint machine ID is read from the session list. An asynchronous isolate request is sent to all associated endpoints, which includes an isolation authentication server URI and the COI configuration for the isolation global role that the endpoint is to move to, and the session with the isolated endpoint is ended. The endpoint being isolated closes any open tunnels and deletes the operational COI configuration, then activates the isolation role COI configuration and issues a <tuples> request to the Isolation authentication server URI, to open a cryptographically-segmented network session with the isolation authentication server. In this case, the isolation authentication server does not find the endpoint machine ID from the <tuples> request in the list of isolated endpoints, but does find the user ID in the list of isolated users. The isolation authentication server opens a Cryptographically-segmented network session to the endpoint, marking the session as isolated by user ID, and provides a session ID and the isolation role COI configuration. The endpoint recognizes that its active COI configuration has the same Hash as the ‘new’ isolation role COI configuration from the <tuples> response, therefore there is no need to close and discard the active COI configuration (Smart Rekey).

D. Isolate an Offline Cryptographically-Segmented-Network-Enabled Endpoint by User ID

An endpoint is not cryptographically-segmented network enabled, not authenticated, when the isolate command is issued. The User ID, its associated isolation global role, and the isolation authentication server URI, are added to the list of isolated users in the enterprise manager and the isolate command is forwarded to all authentication servers. The authentication servers, added the user ID along with its associated isolation global role and isolation authentication server URI to their list of isolated users. When an authentication server receives the <tuples> request, request to authenticate from the endpoint, it does not find the endpoint machine ID from the <tuples> request in its list of isolated endpoints, but does find the user ID in its list of isolated users. The authentication server-AuthGroup determines it is not the isolation authentication server for this User ID, so the authentication server-AuthGroup provides the isolation role COI configuration and isolation authentication server URI, but no session ID in the <tuples> response, and terminates the session. The endpoint responds by closing the service COI tunnel to the authentication server, loading the isolation role COI configuration and issuing a <tuples> request to the isolation authentication server URI to open a Cryptographically-segmented network session with the isolation authentication server. The isolation sequence completes as described in use case C.

E. Isolate an Endpoint, Currently Isolated by User ID, by Endpoint Machine ID

An isolate command is issued with the machine ID of a specific endpoint to be isolated. The endpoint machine ID is added to the list of isolated endpoints in the enterprise manager and an isolate command is forwarded to all authentication servers. The authentication servers add the endpoint machine ID to their list of isolated endpoints and scan their current session list for any endpoint machine ID matches. A match is detected on an active session. That session indicates the endpoint is operating in an isolation global role and was isolated by user ID. The authentication server that is monitoring the active session sends the endpoint an asynchronous isolate command with the isolation authentication server URI and the COI configuration for the isolation role, as specified by the isolate by endpoint machine ID command, and terminates the session with the endpoint. The endpoint being isolated closes any open tunnels and deletes the operational COI configuration, then activates the isolation role COI configuration and issues a <tuples> request to the isolation authentication server URI to initiate a session with the isolation authentication server.

F. Isolate an Endpoint, Currently Isolated by Endpoint Machine ID, by User ID

An isolate command is issued for a specific user ID to be isolated. The user ID, its associated isolation global role, and the isolation authentication server URI, is added to the list of isolated users in the enterprise manager and the isolate command is forwarded to all authentication servers. The authentication servers, add the user ID along with its associated isolation global Role and isolation authentication server URI to their list of isolated users and scan their current session list for any user ID matches. For all sessions where a match is detected, extract the endpoint machine ID from the session list and note that the endpoint machine ID is marked as isolated. Based on the indication that the endpoint is isolated by endpoint machine ID, the detecting authentication servers do nothing and terminate the operation.

G. Move an Endpoint, Isolated by Endpoint Machine ID, from One Isolation Role to a Different Isolation Role

An endpoint is in an isolated state when another isolate command is issued with a different isolation role for that endpoint, which is currently isolated. The associated role ID and the isolation authentication server URI is updated in the enterprise manager's list of isolated endpoints and the command is forwarded to all authentication servers. The authentication servers update the role ID and isolation authentication server URI in their respective list of isolated endpoints. The isolation authentication server, that is monitoring the isolated endpoint(s), sends the endpoint(s) an asynchronous isolate command, the COI configuration for the new isolation role, and the new isolation authentication server URI. The isolated endpoint(s) closes any open tunnels, deletes the old isolation role COI configuration, and then activates the new isolation role COI configuration from the new isolation role and issues a <tuples> request to the isolation authentication server URI.

H. Move an Endpoint, Isolated by User ID, to a Different Isolation Role

An endpoint is cryptographically-segmented-network-enabled, operating in an isolated state due to isolation by user ID, when the isolate command is issued for that user ID but specifies a different isolation global role. In the enterprise manager's list of isolated users, the user's associated isolation global role is updated along with the isolation authentication server URI, and the isolate command is forwarded to all authentication servers. The authentication servers, update the user ID's associated isolation global Role and isolation authentication server URI in their list of isolated users and scan their current session list for any user ID matches. The isolation authentication server, that is monitoring the isolated endpoint(s), detects a match on the user ID of a session with an isolated endpoint(s) and extracts the endpoint machine ID(s) from the session list. It then, sends, to all identified endpoints marked as isolated by user ID, an asynchronous isolate command that contains the COI configuration for the isolation global role that the endpoint(s) is to move to. Any endpoint being isolated closes any open tunnels and deletes the operational COI configuration, then activates the isolation role COI configuration and issues a <tuples> request to the isolation authentication server URI.

J. Reinstate an Online Isolated Endpoint Isolated by Endpoint Machine ID

An endpoint, isolated by endpoint machine ID, is in an isolated state when an un-isolate command for that endpoint machine ID is issued. The endpoint machine ID is deleted from the list of isolated endpoints in the enterprise manager and the un-isolate command is forward to all authentication servers. The authentication servers delete the endpoint machine ID from their respective list of isolated endpoints. The authentication servers scan their session list for any active session with that endpoint machine ID. The isolation authentication server that is monitoring the isolated endpoint, detects a match and sends the endpoint an asynchronous un-isolate command. The endpoint closes any open tunnels, deletes the operational COI configuration, and resets its cryptographically-segmented network interface, leaving the endpoint in an unauthorized cryptographically-segmented network not enabled state. The endpoint returns to its initial service configuration as defined in a corresponding settings XML file, for example. Depending on the mode of the endpoint (Server or Client and Always-on or On demand), the endpoint may automatically issue a <tuples> request or wait for a user to logon and/or make a request to be cryptographically-segmented network enabled from the Cryptographically-segmented network Dashboard that then results in a <tuples> request for the endpoint to be Cryptographically-segmented network enabled. At this point, if the <tuples> request is authenticating to a user ID that is in the list of isolated users, then the endpoint will be isolated as described in use case D. Otherwise, the authentication process proceeds as normal.

K. Reinstate an Offline Isolated Endpoint Isolated by Endpoint Machine ID

An un-isolate command is issued for an endpoint machine ID of an endpoint that is in the list of isolated endpoints and is not currently on-line. The endpoint machine ID is deleted from the list of isolated endpoints in the enterprise manager and the un-isolate command is forwarded to all authentication servers. The authentication servers delete the endpoint machine ID from their respective list of isolated endpoints. The authentication servers scan their session list for any active session with that endpoint machine ID. No matches are found. When a <tuples> request is made from an endpoint with that endpoint machine ID, the request will be authenticated normally.

L. Reinstate a User ID that was Previously Isolated

An un-isolate command is issued for a user ID and that user ID exists in the list of isolated users in the enterprise manager. The enterprise manager deletes the user ID from the list of isolated users and the un-isolate command is forwarded to all authentication servers. Upon receipt of the un-isolate user ID command from the enterprise manager, the authentication servers delete the user ID from their respective list of isolated users. Upon removal of the user ID from the list of isolated users, the isolation authentication server scans its session list and for active sessions with that user ID that are marked as isolated by user ID and sends an asynchronous un-isolate command to any endpoints it found that match. Upon receipt of the un-isolate command, the endpoint closes any open tunnels, deletes the isolation COI configuration, and resets its cryptographically-segmented network endpoints, leaving the endpoint in an unauthorized cryptographically-segmented network not enabled state. The endpoint returns to its initial configuration as defined in its settings.XML file. Depending on the mode of the endpoint (Server or Client and Always-on or On demand), the endpoint may automatically issue a <tuples> request or wait for a user to logon and/or request to enable Cryptographically-segmented network from the cryptographically-segmented network Dashboard that then results in a <tuples> request for the endpoint to be Cryptographically-segmented network enabled.

M. Reinstate an Endpoint Machine ID for an Endpoint Machine ID that is not Isolated

An un-isolate command is issued for an endpoint machine ID that is not in the enterprise manager's list of isolated endpoints, an informational error status is returned indicating that an un-isolate command was issued for an endpoint machine ID without a corresponding isolate command having been issued for that endpoint machine ID.

N. Reinstate a User ID for a User ID that is not Isolated

An un-isolate command is issued for a user ID that is not in the enterprise manager's list of isolated users, an informational error status is returned indicating that an un-isolate command was issued for a user ID without a corresponding isolate command having been issued for that user ID.

O. Endpoint Isolated by User ID, User Logs Off (Mode: Client-Always-on or Client-On-Demand)

An endpoint is operating from a cryptographically-segmented network isolated global role, previously having been isolated by user ID, now the user logs off resulting in a request to terminate the Cryptographically-segmented network session with the isolation authentication server. The authentication server sends an asynchronous un-isolate command to the endpoint and terminates the session. In response to the un-isolate command, the endpoint closes any open Cryptographically-segmented network tunnels, deletes the isolation COI configuration, and resets its Cryptographically-segmented network endpoints, leaving the endpoint in an unauthorized Cryptographically-segmented network not enabled state. The endpoint returns to its initial configuration as defined in its settings.XML file.

### V. ADDITIONAL EXAMPLES

Example 1 is a server for use in a cryptographically-segmented network, the server comprising: computing hardware including at least one processor and memory circuitry, the memory circuitry comprising instructions that, when executed by the server, cause the server to: establish at least one cryptographically-segmented communication channel for use by authorized endpoints in an operationally-deployed configuration; in response to a received endpoint-isolation command to isolate a first endpoint, de-authorize the first endpoint from the at least one cryptographically-segmented communication channel in the operationally-deployed configuration; and in response to the de-authorization of the first endpoint from the at least one cryptographically-segmented communication channel in the operationally-deployed configuration, issue a configuration instruction to the first endpoint to join a first cryptographically-segmented isolation communication channel that is cryptographically isolated from the at least one cryptographically-segmented communication channel in the operationally-deployed configuration, wherein the first cryptographically-segmented isolation communication channel is communicatively coupled with at least one monitoring endpoint configured to monitor operation of the first endpoint via the first cryptographically-segmented isolation communication channel.

In Example 2, the subject matter of Example 1 includes, wherein the at least one cryptographically-segmented communication channel of the operationally-deployed configuration and the first cryptographically-segmented isolation communication channel are defined according to respective community-of-interest (COI) configurations.

In Example 3, the subject matter of Examples 1-2 includes, wherein the endpoint-isolation command is based on an application programming interface (API) call.

In Example 4, the subject matter of Examples 1-3 includes, wherein the instructions, when executed by the server, cause the server to perform endpoint access-control operations including endpoint authentication operations.

In Example 5, the subject matter of Example 4 includes, wherein the endpoint authentication operations include endpoint authentication based on machine ID, and endpoint authentication based on user ID.

In Example 6, the subject matter of Examples 4-5 includes, wherein the endpoint authentication operations are performed via a cryptographically-segmented licensing communication channel that is cryptographically isolated from the at least one cryptographically-segmented communication channel and from the first cryptographically-segmented isolation communication channel.

In Example 7, the subject matter of Examples 1-6 includes, wherein the instructions, when executed, cause the computing hardware to further: receive monitored operational information about the first endpoint from the at least one monitoring endpoint via a cryptographically-segmented communication channel that is cryptographically isolated from the at least one cryptographically-segmented communication channel and from the first cryptographically-segmented isolation communication channel.

In Example 8, the subject matter of Examples 1-7 includes, wherein the instructions, when executed, cause the computing hardware to further: remotely command the at least one monitoring endpoint, via a cryptographically-segmented communication channel that is cryptographically isolated from the at least one cryptographically-segmented communication channel and from the first cryptographically-segmented isolation communication channel, to probe or reconfigure the first endpoint.

In Example 9, the subject matter of Examples 1-8 includes, wherein the instructions, when executed, cause the computing hardware to further: establish a plurality of cryptographically-segmented isolation communication channels, each of which is cryptographically isolated from the at least one cryptographically-segmented communication channel, and from other ones of the plurality of cryptographically-segmented isolation communication channels, wherein the first cryptographically-segmented isolation communication channel is one of the plurality of the cryptographically-segmented isolation communication channels.

In Example 10, the subject matter of Example 9 includes, wherein the plurality of cryptographically-segmented isolation communication channels include a honeypot communication channel that is cryptographically isolated from the at least one cryptographically-segmented communication channel, and from the first cryptographically-segmented isolation communication channel, wherein the honeypot communication channel is communicatively coupled to at least one honeypot endpoint and to the first endpoint.

In Example 11, the subject matter of Example 10 includes, wherein the plurality of cryptographically-segmented isolation communication channels include a honeypot-control communication channel that is cryptographically isolated from the at least one cryptographically-segmented communication channel, from the first cryptographically-segmented isolation communication channel, and from the from the honeypot communication channel, wherein the honeypot-control communication channel is communicatively coupled to the at least one honeypot endpoint and to the at least one monitoring endpoint.

In Example 12, the subject matter of Examples 1-11 includes, wherein the instructions, when executed, cause the computing hardware to further: issue a un-isolation command to de-authorize the first endpoint from the first cryptographically-segmented isolation communication channel; and in response to the de-authorization of the first endpoint from the first cryptographically-segmented isolation communication channel, issue a configuration instruction to the first endpoint to rejoin the at least one cryptographically-segmented communication channel in the operationally-deployed configuration.

In Example 13, the subject matter of Examples 1-12 includes, wherein the instructions, when executed, cause the computing hardware to further: store a data structure representing endpoints to be isolated; and in response to the received endpoint-isolation command to isolate the first endpoint, update the data structure to include the first endpoint as one of the endpoints to be isolated.

Example 14 is an automated method for operating a cryptographically-segmented network, the method being carried out by a server and comprising: establishing at least one cryptographically-segmented communication channel for use by authorized endpoints in an operationally-deployed configuration; in response to a received endpoint-isolation command to isolate a first endpoint, de-authorizing the first endpoint from the at least one cryptographically-segmented communication channel in the operationally-deployed configuration; and in response to the de-authorizing of the first endpoint from the at least one cryptographically-segmented communication channel in the operationally-deployed configuration, issuing a configuration instruction to the first endpoint to join a first cryptographically-segmented isolation communication channel that is cryptographically isolated from the at least one cryptographically-segmented communication channel in the operationally-deployed configuration, wherein the first cryptographically-segmented isolation communication channel is communicatively coupled with at least one monitoring endpoint configured to monitor operation of the first endpoint via the first cryptographically-segmented isolation communication channel.

In Example 15, the subject matter of Example 14 includes, wherein the at least one cryptographically-segmented communication channel of the operationally-deployed configuration and the first cryptographically-segmented isolation communication channel are defined according to respective community-of-interest (COI) configurations.

In Example 16, the subject matter of Examples 14-15 includes, wherein the endpoint-isolation command is based on an application programming interface (API) call.

In Example 17, the subject matter of Examples 14-16 includes, performing endpoint access-control operations including endpoint authentication operations.

In Example 18, the subject matter of Example 17 includes, wherein the endpoint authentication operations include endpoint authentication based on machine ID, and endpoint authentication based on user ID.

In Example 19, the subject matter of Examples 17-18 includes, wherein the endpoint authentication operations are performed via a cryptographically-segmented licensing communication channel that is cryptographically isolated from the at least one cryptographically-segmented communication channel and from the first cryptographically-segmented isolation communication channel.

In Example 20, the subject matter of Examples 14-19 includes, receiving monitored operational information about the first endpoint from the at least one monitoring endpoint via a cryptographically-segmented communication channel that is cryptographically isolated from the at least one cryptographically-segmented communication channel and from the first cryptographically-segmented isolation communication channel.

In Example 21, the subject matter of Examples 14-20 includes, remotely commanding the at least one monitoring endpoint, via a cryptographically-segmented communication channel that is cryptographically isolated from the at least one cryptographically-segmented communication channel and from the first cryptographically-segmented isolation communication channel, to probe or reconfigure the first endpoint.

In Example 22, the subject matter of Examples 14-21 includes, establishing a plurality of cryptographically-segmented isolation communication channels, each of which is cryptographically isolated from the at least one cryptographically-segmented communication channel, and from other ones of the plurality of cryptographically-segmented isolation communication channels, wherein the first cryptographically-segmented isolation communication channel is one of the plurality of the cryptographically-segmented isolation communication channels.

In Example 23, the subject matter of Example 22 includes, wherein the plurality of cryptographically-segmented isolation communication channels include a honeypot communication channel that is cryptographically isolated from the at least one cryptographically-segmented communication channel, and from the first cryptographically-segmented isolation communication channel, wherein the honeypot communication channel is communicatively coupled to at least one honeypot endpoint and to the first endpoint.

In Example 24, the subject matter of Example 23 includes, wherein the plurality of cryptographically-segmented isolation communication channels include a honeypot-control communication channel that is cryptographically isolated from the at least one cryptographically-segmented communication channel, from the first cryptographically-segmented isolation communication channel, and from the from the honeypot communication channel, wherein the honeypot-control communication channel is communicatively coupled to the at least one honeypot endpoint and to the at least one monitoring endpoint.

In Example 25, the subject matter of Examples 14-24 includes, issuing a un-isolation command to de-authorize the first endpoint from the first cryptographically-segmented isolation communication channel; and in response to the de-authorization of the first endpoint from the first cryptographically-segmented isolation communication channel, issuing a configuration instruction to the first endpoint to rejoin the at least one cryptographically-segmented communication channel in the operationally-deployed configuration.

In Example 26, the subject matter of Examples 14-25 includes, storing a data structure representing endpoints to be isolated; and in response to the received endpoint-isolation command to isolate the first endpoint, updating the data structure to include the first endpoint as one of the endpoints to be isolated.

Example 27 is a at least one non-transitory machine-readable storage medium containing instructions that, when executed by the a server of a network, cause the server to: establish at least one cryptographically-segmented communication channel for use by authorized endpoints in an operationally-deployed configuration; in response to a received endpoint-isolation command to isolate a first endpoint, de-authorize the first endpoint from the at least one cryptographically-segmented communication channel in the operationally-deployed configuration; and in response to the de-authorization of the first endpoint from the at least one cryptographically-segmented communication channel in the operationally-deployed configuration, issue a configuration instruction to the first endpoint to join a first cryptographically-segmented isolation communication channel that is cryptographically isolated from the at least one cryptographically-segmented communication channel in the operationally-deployed configuration, wherein the first cryptographically-segmented isolation communication channel is communicatively coupled with at least one monitoring endpoint configured to monitor operation of the first endpoint via the first cryptographically-segmented isolation communication channel.

In Example 28, the subject matter of Example 27 includes, wherein the at least one cryptographically-segmented communication channel of the operationally-deployed configuration and the first cryptographically-segmented isolation communication channel are defined according to respective community-of-interest (COI) configurations.

In Example 29, the subject matter of Examples 27-28 includes, wherein the endpoint-isolation command is based on an application programming interface (API) call.

In Example 30, the subject matter of Examples 27-29 includes, wherein the instructions, when executed by the server, cause the server to perform endpoint access-control operations including endpoint authentication operations.

In Example 31, the subject matter of Example 30 includes, wherein the endpoint authentication operations include endpoint authentication based on machine ID, and endpoint authentication based on user ID.

In Example 32, the subject matter of Examples 30-31 includes, wherein the endpoint authentication operations are performed via a cryptographically-segmented licensing communication channel that is cryptographically isolated from the at least one cryptographically-segmented communication channel and from the first cryptographically-segmented isolation communication channel.

In Example 33, the subject matter of Examples 27-32 includes, wherein the instructions, when executed, cause the server to further: receive monitored operational information about the first endpoint from the at least one monitoring endpoint via a cryptographically-segmented communication channel that is cryptographically isolated from the at least one cryptographically-segmented communication channel and from the first cryptographically-segmented isolation communication channel.

In Example 34, the subject matter of Examples 27-33 includes, wherein the instructions, when executed, cause the server to further: remotely command the at least one monitoring endpoint, via a cryptographically-segmented communication channel that is cryptographically isolated from the at least one cryptographically-segmented communication channel and from the first cryptographically-segmented isolation communication channel, to probe or reconfigure the first endpoint.

In Example 35, the subject matter of Examples 27-34 includes, wherein the instructions, when executed, cause the server to further: establish a plurality of cryptographically-segmented isolation communication channels, each of which is cryptographically isolated from the at least one cryptographically-segmented communication channel, and from other ones of the plurality of cryptographically-segmented isolation communication channels, wherein the first cryptographically-segmented isolation communication channel is one of the plurality of the cryptographically-segmented isolation communication channels.

In Example 36, the subject matter of Example 35 includes, wherein the plurality of cryptographically-segmented isolation communication channels include a honeypot communication channel that is cryptographically isolated from the at least one cryptographically-segmented communication channel, and from the first cryptographically-segmented isolation communication channel, wherein the honeypot communication channel is communicatively coupled to at least one honeypot endpoint and to the first endpoint.

In Example 37, the subject matter of Example 36 includes, wherein the plurality of cryptographically-segmented isolation communication channels include a honeypot-control communication channel that is cryptographically isolated from the at least one cryptographically-segmented communication channel, from the first cryptographically-segmented isolation communication channel, and from the from the honeypot communication channel, wherein the honeypot-control communication channel is communicatively coupled to the at least one honeypot endpoint and to the at least one monitoring endpoint.

In Example 38, the subject matter of Examples 27-37 includes, wherein the instructions, when executed, cause the server to further: issue a un-isolation command to de-authorize the first endpoint from the first cryptographically-segmented isolation communication channel; and in response to the de-authorization of the first endpoint from the first cryptographically-segmented isolation communication channel, issue a configuration instruction to the first endpoint to rejoin the at least one cryptographically-segmented communication channel in the operationally-deployed configuration.

In Example 39, the subject matter of Examples 27-38 includes, wherein the instructions, when executed, cause the server to further: store a data structure representing endpoints to be isolated; and in response to the received endpoint-isolation command to isolate the first endpoint, update the data structure to include the first endpoint as one of the endpoints to be isolated.

Example 40 is at least one machine-readable medium including instructions that, when executed by processing circuitry, cause the processing circuitry to perform operations to implement of any of Examples 1-39.

Example 41 is an apparatus comprising means to implement of any of Examples 1-39.

Example 42 is a system to implement of any of Examples 1-39.

Example 43 is a method to implement of any of Examples 1-39.

In related embodiments, isolation of an endpoint that is a member of one or more roles or COIs is effected by updating the COI keys of the not-to-be-isolated endpoints belonging to the roles or COIs of the endpoint to be isolated. This variation offers an advantage of avoiding reliance on the endpoint to be isolated to comply with the isolate command by closing its open tunnels, configuring to the isolation role, etc. This approach provides enhanced security at the cost of increased networking overhead to effect the COI key updating among a potentially large number of non-isolating endpoints.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and operations described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A server for use in a cryptographically-segmented network, the server comprising:
computing hardware including at least one processor and memory circuitry, the memory circuitry comprising instructions that, when executed by the server, cause the server to:
establish at least one cryptographically-segmented communication channel for use by authorized endpoints in an operationally-deployed configuration;
in response to a received endpoint-isolation command to isolate a first endpoint, de-authorize the first endpoint from the at least one cryptographically-segmented communication channel in the operationally-deployed configuration; and
in response to the de-authorization of the first endpoint from the at least one cryptographically-segmented communication channel in the operationally-deployed configuration, issue a configuration instruction to the first endpoint to join a first cryptographically-segmented isolation communication channel that is cryptographically isolated from the at least one cryptographically-segmented communication channel in the operationally-deployed configuration, wherein the first cryptographically-segmented isolation communication channel is communicatively coupled with at least one monitoring endpoint configured to monitor operation of the first endpoint via the first cryptographically-segmented isolation communication channel.

2. The server of claim 1, wherein the at least one cryptographically-segmented communication channel of the operationally-deployed configuration and the first cryptographically-segmented isolation communication channel are defined according to respective community-of-interest (COI) configurations.

3. The server of claim 1, wherein the endpoint-isolation command is based on an application programming interface (API) call.

4. The server of claim 1, wherein the instructions, when executed by the server, cause the server to perform endpoint access-control operations including endpoint authentication operations.

5. The server of claim 4, wherein the endpoint authentication operations include endpoint authentication based on machine ID, and endpoint authentication based on user ID.

6. The server of claim 4, wherein the endpoint authentication operations are performed via a cryptographically-segmented licensing communication channel that is cryptographically isolated from the at least one cryptographically-segmented communication channel and from the first cryptographically-segmented isolation communication channel.

7. The server of claim 1, wherein the instructions, when executed, cause the computing hardware to further:
receive monitored operational information about the first endpoint from the at least one monitoring endpoint via a cryptographically-segmented communication channel that is cryptographically isolated from the at least one cryptographically-segmented communication channel and from the first cryptographically-segmented isolation communication channel.

8. The server of claim 1, wherein the instructions, when executed, cause the computing hardware to further:
remotely command the at least one monitoring endpoint, via a cryptographically-segmented communication channel that is cryptographically isolated from the at least one cryptographically-segmented communication channel and from the first cryptographically-segmented isolation communication channel, to probe or reconfigure the first endpoint.

9. The server of claim 1, wherein the instructions, when executed, cause the computing hardware to further:
establish a plurality of cryptographically-segmented isolation communication channels, each of which is cryptographically isolated from the at least one cryptographically-segmented communication channel, and from other ones of the plurality of cryptographically-segmented isolation communication channels, wherein the first cryptographically-segmented isolation communication channel is one of the plurality of the cryptographically-segmented isolation communication channels.

10. The server of claim 9, wherein the plurality of cryptographically-segmented isolation communication channels include a honeypot communication channel that is cryptographically isolated from the at least one cryptographically-segmented communication channel, and from the first cryptographically-segmented isolation communication channel, wherein the honeypot communication channel is communicatively coupled to at least one honeypot endpoint and to the first endpoint.

11. The server of claim 10, wherein the plurality of cryptographically-segmented isolation communication channels include a honeypot-control communication channel that is cryptographically isolated from the at least one cryptographically-segmented communication channel, from the first cryptographically-segmented isolation communication channel, and from the from the honeypot communication channel, wherein the honeypot-control communication channel is communicatively coupled to the at least one honeypot endpoint and to the at least one monitoring endpoint.

12. The server of claim 1, wherein the instructions, when executed, cause the computing hardware to further:
issue a un-isolation command to de-authorize the first endpoint from the first cryptographically-segmented isolation communication channel; and
in response to the de-authorization of the first endpoint from the first cryptographically-segmented isolation communication channel, issue a configuration instruction to the first endpoint to rejoin the at least one cryptographically-segmented communication channel in the operationally-deployed configuration.

13. The server of claim 1, wherein the instructions, when executed, cause the computing hardware to further:
store a data structure representing endpoints to be isolated; and
in response to the received endpoint-isolation command to isolate the first endpoint, update the data structure to include the first endpoint as one of the endpoints to be isolated.

14. An automated method for operating a cryptographically-segmented network, the method being carried out by a server and comprising:
establishing at least one cryptographically-segmented communication channel for use by authorized endpoints in an operationally-deployed configuration;
in response to a received endpoint-isolation command to isolate a first endpoint, de-authorizing the first endpoint from the at least one cryptographically-segmented communication channel in the operationally-deployed configuration; and
in response to the de-authorizing of the first endpoint from the at least one cryptographically-segmented communication channel in the operationally-deployed configuration, issuing a configuration instruction to the first endpoint to join a first cryptographically-segmented isolation communication channel that is cryptographically isolated from the at least one cryptographically-segmented communication channel in the operationally-deployed configuration, wherein the first cryptographically-segmented isolation communication channel is communicatively coupled with at least one monitoring endpoint configured to monitor operation of the first endpoint via the first cryptographically-segmented isolation communication channel.

15. The method of claim 14, further comprising:
performing endpoint access-control operations including endpoint authentication operations, wherein the endpoint authentication operations include endpoint authentication based on machine ID, and endpoint authentication based on user ID.

16. The method of claim 14, further comprising:
receiving monitored operational information about the first endpoint from the at least one monitoring endpoint via a cryptographically-segmented communication channel that is cryptographically isolated from the at least one cryptographically-segmented communication channel and from the first cryptographically-segmented isolation communication channel.

17. The method of claim 14, further comprising:
remotely commanding the at least one monitoring endpoint, via a cryptographically-segmented communication channel that is cryptographically isolated from the at least one cryptographically-segmented communication channel and from the first cryptographically-segmented isolation communication channel, to probe or reconfigure the first endpoint.

18. The method of claim 14, further comprising:
establishing a plurality of cryptographically-segmented isolation communication channels, each of which is cryptographically isolated from the at least one cryptographically-segmented communication channel, and from other ones of the plurality of cryptographically-segmented isolation communication channels, wherein the first cryptographically-segmented isolation communication channel is one of the plurality of the cryptographically-segmented isolation communication channels;
wherein the plurality of cryptographically-segmented isolation communication channels include a honeypot communication channel that is cryptographically isolated from the at least one cryptographically-segmented communication channel, and from the first cryptographically-segmented isolation communication channel, wherein the honeypot communication channel is communicatively coupled to at least one honeypot endpoint and to the first endpoint; and
wherein the plurality of cryptographically-segmented isolation communication channels include a honeypot-control communication channel that is cryptographically isolated from the at least one cryptographically-segmented communication channel, from the first cryptographically-segmented isolation communication channel, and from the from the honeypot communication channel, wherein the honeypot-control communication channel is communicatively coupled to the at least one honeypot endpoint and to the at least one monitoring endpoint.

19. The method of claim 14, further comprising:
issuing a un-isolation command to de-authorize the first endpoint from the first cryptographically-segmented isolation communication channel; and
in response to the de-authorization of the first endpoint from the first cryptographically-segmented isolation communication channel, issuing a configuration instruction to the first endpoint to rejoin the at least one cryptographically-segmented communication channel in the operationally-deployed configuration.

20. A at least one non-transitory machine-readable storage medium containing instructions that, when executed by the a server of a network, cause the server to:
establish at least one cryptographically-segmented communication channel for use by authorized endpoints in an operationally-deployed configuration;
in response to a received endpoint-isolation command to isolate a first endpoint, de-authorize the first endpoint from the at least one cryptographically-segmented communication channel in the operationally-deployed configuration; and
in response to the de-authorization of the first endpoint from the at least one cryptographically-segmented communication channel in the operationally-deployed configuration, issue a configuration instruction to the first endpoint to join a first cryptographically-segmented isolation communication channel that is cryptographically isolated from the at least one cryptographically-segmented communication channel in the operationally-deployed configuration, wherein the first cryptographically-segmented isolation communication channel is communicatively coupled with at least one monitoring endpoint configured to monitor operation of the first endpoint via the first cryptographically-segmented isolation communication channel.
